(19) United States
(12) Patent Application Publication
(10) Pub. No.: US 2026/0168728 A1
(43) Pub. Date: Jun. 18, 2026

(54) GRAIN STORAGE AND CONDITIONING SYSTEM

(71) Applicant: Ryan Kloeckner, Moorhead, MN (US)

(72) Inventor: Ryan Kloeckner, Moorhead, MN (US)

(21) Appl. No.: 18/986,412

(22) Filed: Dec. 18, 2024

(51) Int. Cl. F26B 11/18

(52) U.S. Cl. CPC F26B 11/185

(57) ABSTRACT

A grain conditioning and storage system includes a top load hopper; a pre-cleaner roller set within the top load hopper; and a first modular section along an axis transverse to the pre-cleaner roller set to receive grain from the pre-cleaner roller set, the first modular section extendable and retractable between a deployed condition and a stored condition, the first modular section forms a first rotating drying drum in the deployed condition.

### CROSS REFERENCE TO RELATED APPLICATION[S]

None

### BACKGROUND

The present disclosure relates to a grain conditioning and storage system, and more specifically to a portable, collapsible, modular, conditioning and storage system.

Grain bagging is a proven storage method. Current grain storage bags receive grain from a combine within a stubble field. The air-tight grain bag allows grain to be stored for an extended time in a dry, controlled environment as cleaning and drying occurs at a later time typically at the elevator.

### SUMMARY

A grain conditioning and storage system according to one disclosed non-limiting embodiment of the present disclosure includes a top load hopper; a pre-cleaner roller set within the top load hopper; and a first modular section along an axis transverse to the pre-cleaner roller set to receive grain from the pre-cleaner roller set, the first modular section extendable and retractable between a deployed condition and a stored condition, the first modular section forms a first rotating drying drum in the deployed condition.

A further embodiment of any of the foregoing embodiments of the present disclosure includes that a second modular section along the axis, the second modular section extendable and retractable between a deployed condition and a stored condition, the second modular section forms a second rotating drying drum in the deployed condition.

A further embodiment of any of the foregoing embodiments of the present disclosure includes that the first modular section comprises a multiple of rotating rings.

A further embodiment of any of the foregoing embodiments of the present disclosure includes a mesh outer surface that interconnects each of the multiple of rotating rings.

A further embodiment of any of the foregoing embodiments of the present disclosure includes a multiple of drive bases, each of which at least partially supports one of the multiple of rotating rings.

A further embodiment of any of the foregoing embodiments of the present disclosure includes that each of the multiple of drive bases comprise a semicircular linear electromagnetic motor.

A further embodiment of any of the foregoing embodiments of the present disclosure includes that the semicircular linear electromagnetic motor comprises a semicircular stator which rotates a circular rotor mounted about the rotating ring.

A further embodiment of any of the foregoing embodiments of the present disclosure includes that the semicircular stator magnetically rotates the circular rotor.

A further embodiment of any of the foregoing embodiments of the present disclosure includes an air dryer system that extends through the first modular section along the axis.

A further embodiment of any of the foregoing embodiments of the present disclosure includes that the air dryer system comprises a fan and a flexible perforated tube that extends from the fan along the axis.

A further embodiment of any of the foregoing embodiments of the present disclosure includes a generator system within the top load hopper to communicate heated air into the flexible perforated tube.

A further embodiment of any of the foregoing embodiments of the present disclosure includes that the top load hopper comprises a flexible hopper.

A further embodiment of any of the foregoing embodiments of the present disclosure includes that the pre-cleaner roller set comprises a multiple of perforated rollers.

A further embodiment of any of the foregoing embodiments of the present disclosure includes a fan along a roller axis of each pre-cleaner roller of the pre-cleaner roller set.

A further embodiment of any of the foregoing embodiments of the present disclosure includes that the fan directs an airflow within each respective precleaning roller to facilitate removal of chaff from the grain during precleaning which is blown along each roller axis to be ejected though an exhaust opposite the respective fan.

A further embodiment of any of the foregoing embodiments of the present disclosure includes a sieve structure below the pre-cleaner roller.

A further embodiment of any of the foregoing embodiments of the present disclosure includes that the sieve structure comprises a two-tier arrangement angled at 10 degrees with respect to horizontal toward each side of the top load hopper section.

A further embodiment of any of the foregoing embodiments of the present disclosure includes an unloading section downstream of the first modular section.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of a grain conditioning and storage system according to one disclosed non-limiting embodiment.

FIG. 2 is a partial phantom perspective view of the grain conditioning and storage system in a deployed condition.

FIG. 3 is a partial phantom perspective view of the grain conditioning and storage system in a stored condition.

FIG. 4 is a perspective view of a top load hopper section of the grain conditioning and storage system.

FIG. 5 is a top view of the top load hopper section of the grain conditioning and storage system.

FIG. 6 is a side view of the top load hopper section of the grain conditioning and storage system.

FIG. 7 is a partial phantom side view of the top load hopper section of the grain conditioning and storage system.

FIG. 8A is a side view of a rotating drying drum stage section of the grain conditioning and storage system.

FIG. 8B is a side view of a rotating drying drum stage section of the grain conditioning and storage system according to another disclosed non-limiting embodiment illustrating an outrigger and a weight distribution pad in both a deployed condition and a stored condition.

FIG. 9 is a side perspective view of a rotating drying drum stage section of the grain conditioning and storage system in a stored condition.

FIG. 10 is a general perspective view of a rotating drying drum of the grain conditioning and storage system in a partially collapsed condition illustrating a scissor mechanism.

FIG. 10A is a bottom view of a rotating drying drum stage section of the grain conditioning and storage system in a deployed condition illustrating a scissor mechanism.

FIG. 10B is a perspective view of a scissor mechanism in a deployed condition.

FIG. 10C is a perspective view of a scissor mechanism in a transitional position between a deployed condition and a stored condition.

FIG. 11 is an end view of an unloading section at an end of the rotating drying drum stage section of the grain conditioning and storage system.

FIG. 12 is block diagram of a method of operation of the grain conditioning and storage system.

### DETAILED DESCRIPTION

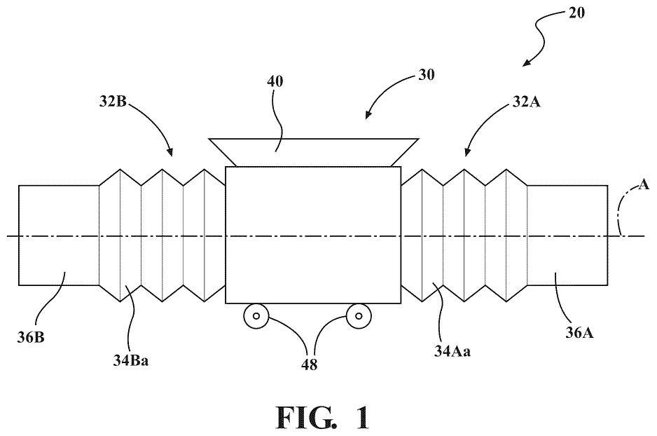

FIG. 1 schematically illustrates a grain conditioning and storage system 20 that is portable, collapsible, and modular. The grain conditioning and storage system 20 may be readily transported to a desired location and expanded to condition and store grain in a field. The grain conditioning and storage system 20 generally includes a top load hopper section 30, a modular section 32A, 32B to receive grain from the top load hopper section 30, a multiple of rotating drying drum stage sections 34Aa-34An, 34Ba-34Bn and an unloading section 36A, 36B. In one embodiment, the modular sections 32A, 32B extend along an axis A on opposed sides of the top load hopper section 30 along an axis A which is generally parallel to the ground.

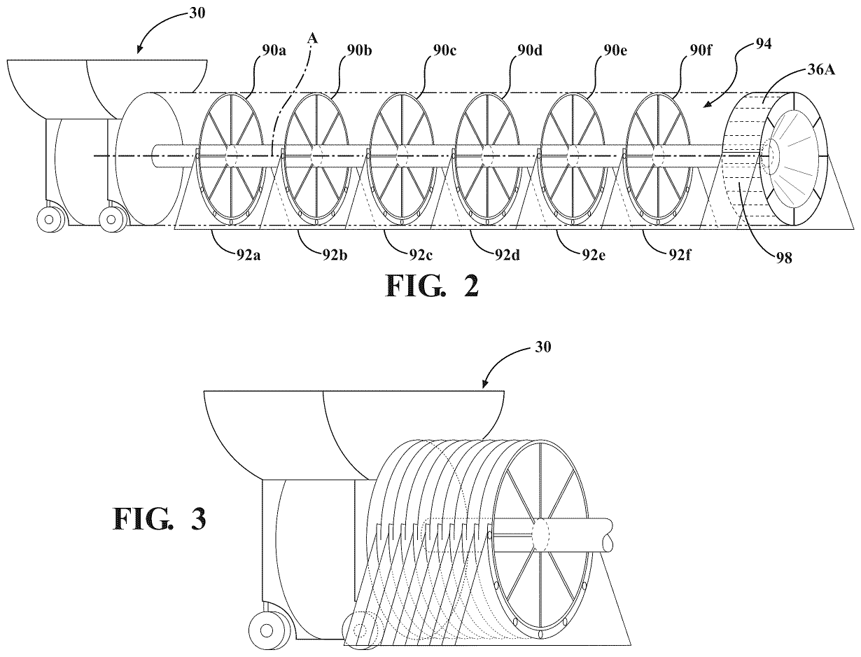

The modular sections 32A, 32B may be manually extended and retracted between a deployed condition (FIG. 2) and a stored condition (FIG. 3) with respect to the top load hopper section 30 along axis A. The top load hopper section 30 may include a wheeled base 48 to facilitate transport in the stored condition.

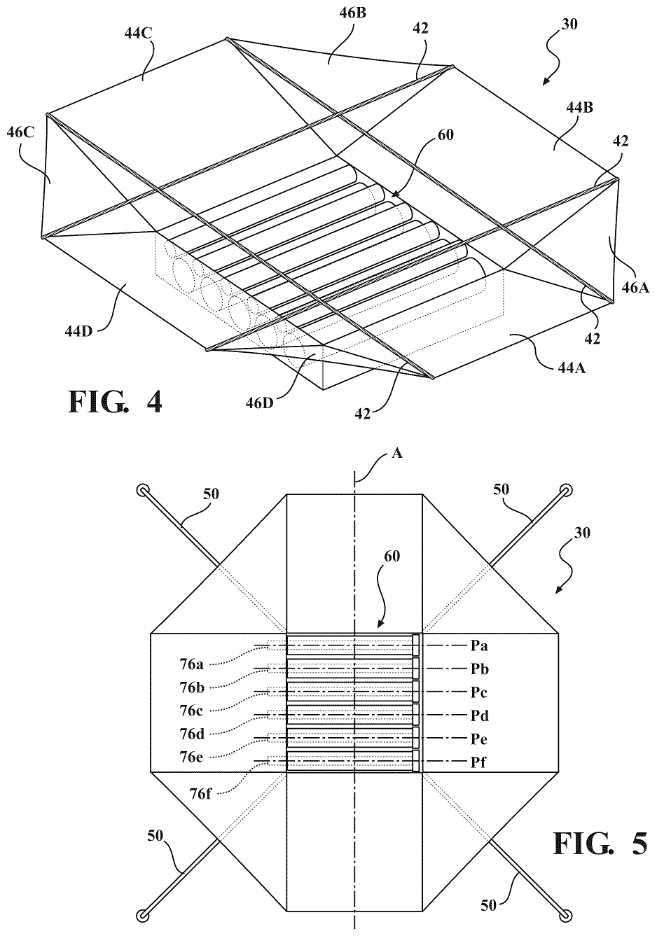

With reference to FIG. 4, the top load hopper section 30, in one embodiment, may include a flexible hopper 40 that may be restrained by cables 42 in an open position. The flexible hopper 40 is readily selectively folded in the stored condition (FIG. 3).

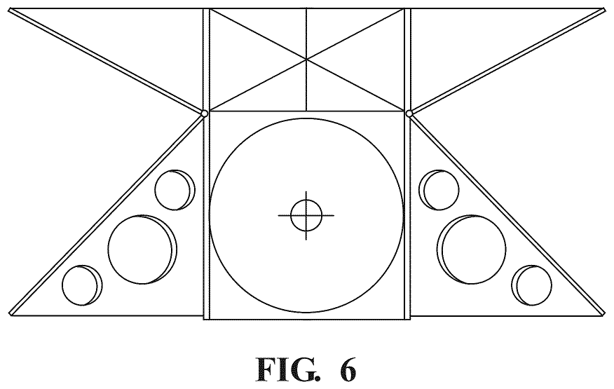

In the deployed condition, the flexible hopper 40 folds outward and cables 42 (four (4) shown) maintain the desired open position. The flexible hopper 40 may include four (4) 8 foot by 8 foot solid panels 44A-44D along with four flexible corner sections 46A-46D. The cables 42 may be connected at each corner of the panels 44A-44D. Each of the four flexible corner sections 46A-46D may be transparent or include transparent windows to facilitate inspection. In the deployed condition, the panels 44A-44D unfold to about, for example, 152 degrees to create an opening with an about 900 bushel capacity for temporary material holding. In the deployed condition, four (4) outrigger struts 50 may be arrayed to facilitate stability when in operation (FIGS. 5 and 6). In one embodiment, the outrigger struts 50 may swing outward, for example, by 45 degrees to provide stability whence significant grain is received, for example, directly from a combine.

The flexible hopper 40 funnels grain into a pre-cleaner roller set 60. The pre-cleaner roller set 60, in one embodiment, may include six (6) 16-inch diameter perforated precleaning rollers 62a-62f and five (5) 8-inch diameter precleaning cylinders 64a-64e across the opening to the flexible hopper 40 and transverse to axis A. The precleaning cylinders 64a-64e may also be perforated. Grain may be loaded onto the perforated precleaning rollers 62a-62f, in a first stage of cleaning. As the grain contacts the precleaning cylinders 64a-64e, the grain is diffused into a thinner vertical material stream to preclean and separate lighter material through opposite ends.

Within each perforated precleaning roller 62a-62f, a secondary perforated cylinder, which when positioned axially a short distance in either direction in relation to the outer cylinder, facilitates material flow regulation for a multitude of crops, or for a complete material shut off from sieves. That is, the secondary perforated cylinder may be positioned such that the perforations in both the perforated precleaning roller and the secondary perforated cylinder are effectively closed. Low velocity bleed air from center tube blower fan may be fed into sieves to assist in material separation. Although six (6) 16-inch diameter perforated precleaning rollers 62a-62f are illustrated in the disclosed embodiment, any number may be utilized.

A pre-cleaner exhaust system 70 may include a fan 72a-72f located along an axis Pa-Pe of each precleaning roller 62a-62f. Each fan 72a-72f may be a 16-inch diameter fan that forms an airflow along, and or within, each respective precleaning roller 62a-62f to facilitate removal of the chaff from the grain during precleaning. That is, the pre-cleaner roller set 60 and pre-cleaner exhaust system 70 provides initial separation of chaff and other debris from the grain which is blown along each roller axis Pa-Pe to be ejected though an exhaust 76a-76f opposite the respective fan 72.

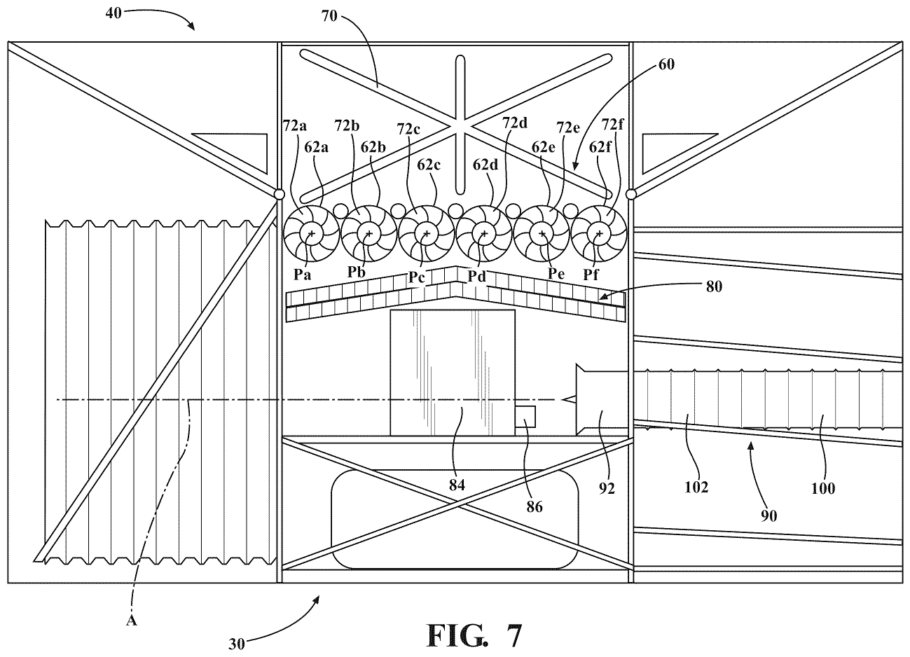

With reference to FIG. 7, the pre-cleaner roller set 60 may be located above a sieve structure 80. That is, the material flow may be controlled onto the underlying sieve structure 80 (also referred to as cleaning shoes) so as not to overload the cleaning system. The sieve structure 80, in one embodiment, may be a two-tier arrangement angled at 10 degrees with respect to horizontal toward each side of the top load hopper section 30 such that the pre-cleaned grain is directed into the modular sections 32A, 32B located along axis A on each side of the top load hopper section 30. That is, the sieve structure 80 directs the grain toward each side of the top load hopper section 30. Once material leaves the pre-cleaner cylinders, the material may enter an angled sieve structure 80 which, in one example, is 128 sq. ft. and vibrates to further separate unwanted crop material. The sieve structure 80 may be suspended from flexible rubber dog bone type links from the outer main frame posts.

A power system 84, for example, a diesel engine and an electric generator, supplies power to drive the pre-cleaner roller set 60 and the pre-cleaner exhaust system 70. Various gear systems, electric motors, etc., may be utilized to power the rotational components. The power system 84 may be located at the base of the top load hopper section 30 and operated in response to a control 86. The control 86 may include at least one processor, e.g., microprocessor, microcontroller, digital signal processor, etc., a memory, and an input/output (I/O) interface. The processor and the I/O interface are communicatively coupled to the memory. The memory may be embodied as various forms of ROM, RAM, which stores data and control algorithms such as the logic described herein to control, for example the selective operation of the pre-cleaner roller set 60 and the pre-cleaner exhaust system 70, etc. The I/O interface is communicatively coupled to a number of hardware, firmware, and/or software components.

An air dryer system 90 may include a fan 92 and a flexible perforated tube 100 that extends along the axis A within each of the modular sections 32A, 32B. The power system 84 may produce heated air that is communicated by the fan 92 through the flexible perforated tube 100 and expressed in radial directions through perforations 102 while the multiple of rotating drying drum stage sections 34Aa-34Af, 34Ba-34Bf are rotated about the axis A. The grain is thereby dried by the heated airflow while the rotation facilitates mixture and even distribution of the grain to assure comprehensive drying.

The multiple of rotating drying drum stage sections 34Aa-34Af, 34Ba-34Bf of the modular sections 32A, 32B can be manually expanded and contracted with respect to the top load hopper section 30. Although the modular section 32A will be described in detail, modular section 32B operates in a fundamentally comparable manner.

The modular sections 32A, 32B each include a multiple (six shown) of rotating rings 90a-90f, with a respective drive base 92a-92f and a mesh outer surface 94 (best seen in FIG. 2). The mesh outer surface 94 interconnects each of the multiple of rotating rings 90a-90f, the top load hopper section 30, and the unloading section 36A, 36B. That is, the mesh outer surface 94 lines the entire extended length and circumference of the multiple of rotating drying drum stage sections 34Aa-34Af, 34Ba-34Bf. The mesh outer surface 94 may be, for example, a Kevlar mesh which is readily expanded and collapsed in response to the modular sections 32A, 32B being manually extended and retracted between the deployed condition (FIG. 2) and the stored condition (FIG. 3).

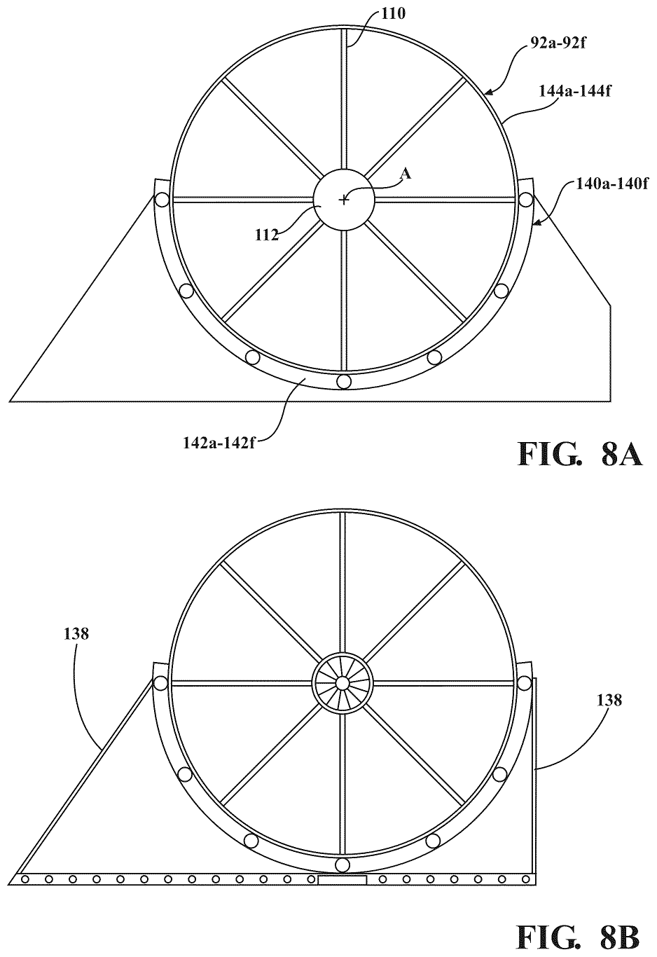

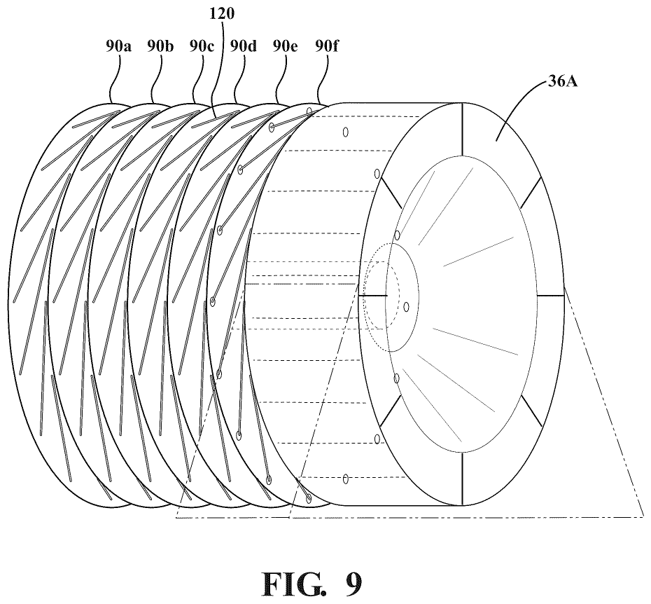

With reference to FIG. 8, each rotating ring 90a-90f may include a multiple of radial braces 110 that extend from an internal hub 112 through which the flexible perforated tube 100 extends and rotates about. A multiple of pivotable longitudinal spars 120 extend between a generally radial arrangement in the stored condition (FIG. 9; to an axial arrangement with respect to axis A in the deployed condition (FIG. 2). The pivotable longitudinal spars 120 may be made of, for example, carbon fiber.

The multiple of pivotable longitudinal spars 120 may be extended to the deployed condition (FIG. 2) by independently rotating each rotating ring 90a-90f, about 90 degrees with respect to the prior rotating ring 90a-90f that is closer to the top load hopper section 30. That is, rotation of each individual rotating ring 90a-90f downstream of a prior rotating ring 90a-90f by about 90 degrees operates to extend the pivotable longitudinal spars 120 to be parallel to axis A such that the multiple of rotating drying drum stage sections 34Aa-34Af, 34Ba-34Bf are then rotatable in unison. Each of the multiple of rotating drying drum stage sections 34Aa-34Af, 34Ba-34Bf may, for example, include eight (8) or more of the pivotable longitudinal spars 120 connected and equally spaced around the rotating rings 90a-90f.

In one embodiment, the pivotable longitudinal spars 120 may be connected via Z-links around the radius of each rotating ring 90a-90f to allow linear flexibility between sections on uneven terrain.

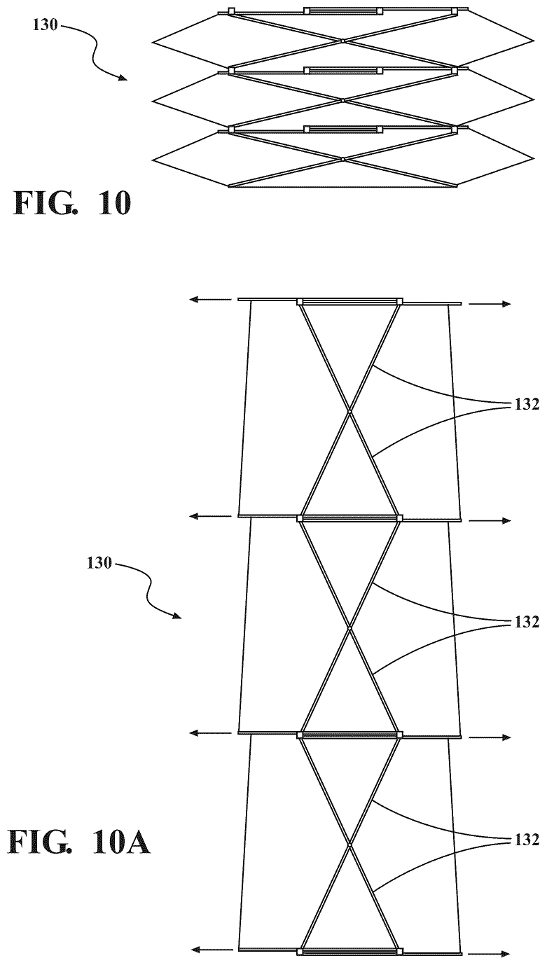

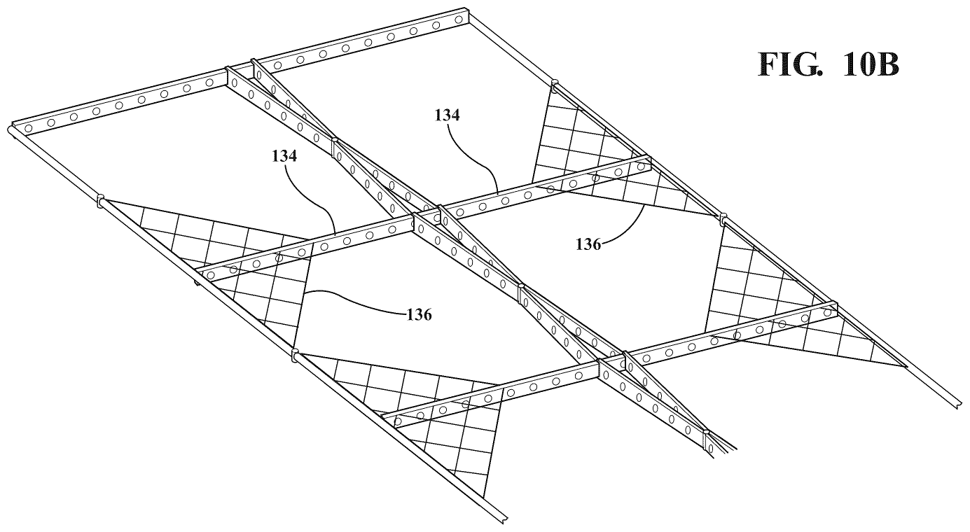

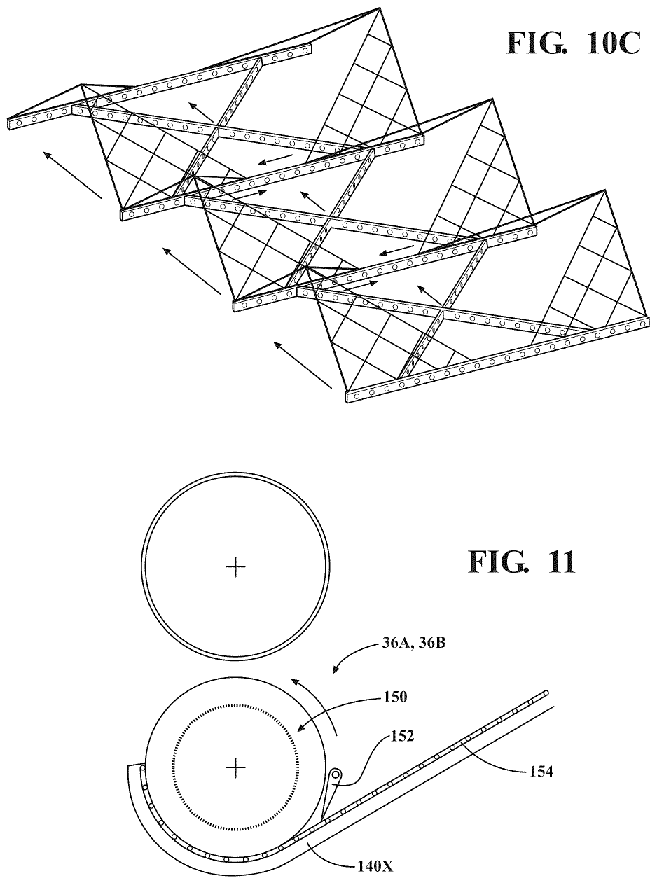

A scissor mechanism 130a-130f (FIG. 10A) may be located between each respective drive base 92a-92f. The scissor mechanism 130a-130f sets the distance between each respective drive base 92a-92f in the deployed condition (FIG. 2) yet permits the modular sections 32A, 32B to collapse to the stored condition (FIG. 3). The scissor mechanism 130a-130f may additionally hold the pivotable longitudinal spars 120 in the extended position to minimize or prevent unwanted retraction while in rotational operation.

In one embodiment, each rotating ring 90a-90f may be rotated with respect to the respective drive base 92a-92f via a semicircular linear electromagnetic motor 140a-140f powered by the power system 84. Each semicircular linear electromagnetic motor 140a-140f may include a semicircular stator 142a-142f which rotates a circular rotor 144a-144f mounted about the rotating ring 90A-90f. Within the semicircular stator 142a-142f may be located rotor rollers 146 which facilitate rotation of the rotating ring 90a-90f. In other embodiments, alternative drive systems such as a rotary servo motor, gear system, etc., may be provided.

In the deployed condition, the mesh outer surface 94 extends between the multiple of rotating rings 90A-90n and is at least partially supported by the multiple of pivotable longitudinal spars 120 to form a relatively rigid rotatable drying drum that tumbles and transits the grain along axis A to the respective unloading section 36A, 36B. The mesh outer surface 94 and or the multiple of pivotable longitudinal spars 120 may include internal contours 98 to facilitate the transit of the grain axially along axis A in response to the rotation toward the respective unloading section 36A, 36B.

With reference to FIGS. 10, 10A, 10B, 10C, the scissor mechanism 130a-130f includes, for example, base spars 132 (FIG. 10A), counter spars 134 (FIG. 10B), pads 136 (FIG. 10B), and drying drum outriggers 138 (FIG. 8B), each made of, for example, carbon fiber. The base spars 132 may be pivotably connected at a distance midway between the rotating rings 90a-90b, 90b-90c, etc. The base spars 132 may be pivotably connected to the counter spars 134 under each rotating ring 90a-90f. The counter spars 134 may counter extend from each other in a transverse direction outward from the axis A. On the outer end of the counter spars 134 are interconnected pads 136 that may fold from a stored position to a deployed (generally horizontal) position when the counter spars 134 are fully counter extended. The pads 136 may be pivotably connected to the counter spars 134 about which they fold and may provide weight distribution and stabilization. Each counter spar 134 may be connected to a respective semicircular stator 142a-142f by a drying drum outrigger 138. The drying drum outrigger may extend to a center of the pad 136.

With reference to FIG. 11, the unloading section 36A, 36B may include a rotating screen assembly 150 driven by a semicircular linear electromagnetic motor 140x and a set of vanes 152. The set of vanes 152 selectively control passage of the grain from the rotating screen assembly 150 to an exit conveyor platform 154. Grain is pushed out through the set of vanes 152 onto the angled exit conveyor platform 154 thence to an awaiting vehicle.

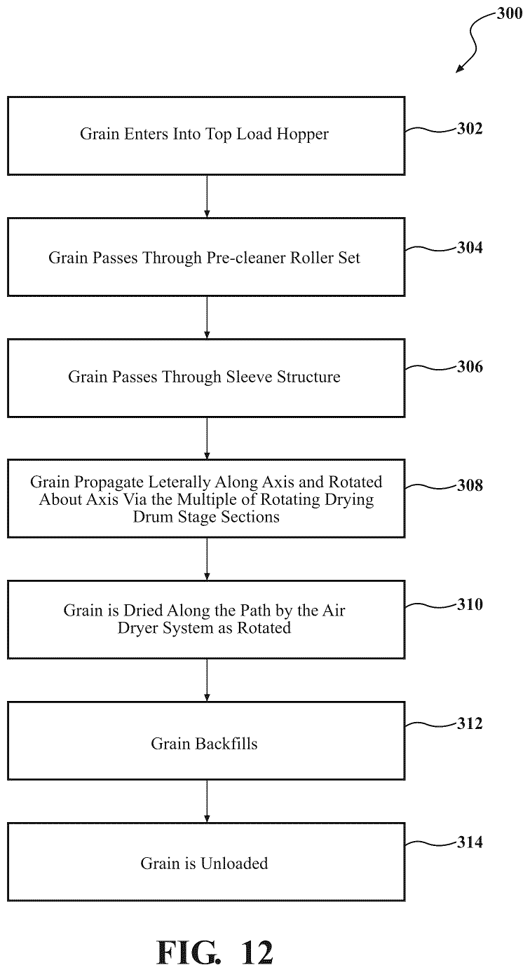

With reference to FIG. 12 a method 300 for operating the grain conditioning and storage system 20 is schematically illustrated. Equipment such as a tractor may be used to extend and retract the modular sections 32A, 32B of the grain conditioning and storage system 20. In other embodiments, the modular sections 32A, 32B may automatically extend and retract, via, for example by powered scissor mechanism 130a-130f.

The material, e.g., grain enters the system through the top load hopper section 30 (transferred from a combine; 302), then progresses through the pre-cleaner roller set 60 (304) such that the desirable grain proceeds by-directionally along the sieve structure 80 (306). The grain is then propagated laterally along axis A through the multiple of rotating drying drum stage sections 34Aa-34Af, 34Ba-34Bf of the modular sections 32A, 32B (308) where it is dried along the path by the air dryer system 90 (310). The slow rotation provides for the desired crop moisture percentage.

The grain is propagated laterally along axis A and rotated about axis A via the multiple of rotating drying drum stage sections 34Aa-34Af, 34Ba-34Bf until reaching the unloading section 36A, 36B such that the unloading section is backfilled to a 75%-80% capacity (312) thence unloaded (314).

Once the grain conditioning and storage system 20 is at capacity, a flexible tarp like material may be rolled along the entire length of the rotating drying drum stage sections 34Aa-34Af, 34Ba-34Bf of the modular sections 32A, 32B for climate protection until the unloading process begins. The grain conditioning and storage system 20 may operate as a way point between harvest and final destination.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed:

1. A grain conditioning and storage system, comprising:
a top load hopper;
a pre-cleaner roller set within the top load hopper; and
a first modular section along an axis transverse to the pre-cleaner roller set to receive grain from the pre-cleaner roller set, the first modular section extendable and retractable between a deployed condition and a stored condition, the first modular section forms a first rotating drying drum in the deployed condition.

2. The system as recited in claim 1, further comprising a second modular section along the axis, the second modular section extendable and retractable between a deployed condition and a stored condition, the second modular section forms a second rotating drying drum in the deployed condition.

3. The system as recited in claim 1, wherein the first modular section comprises a multiple of rotating rings.

4. The system as recited in claim 3, further comprising a mesh outer surface that interconnects each of the multiple of rotating rings.

5. The system as recited in claim 3, further comprising a multiple of drive bases, each of which at least partially supports one of the multiple of rotating rings.

6. The system as recited in claim 5, wherein each of the multiple of drive bases comprise a semicircular linear electromagnetic motor.

7. The system as recited in claim 6, wherein the semicircular linear electromagnetic motor comprises a semicircular stator which rotates a circular rotor mounted about the rotating ring.

8. The system as recited in claim 7, wherein the semicircular stator magnetically rotates the circular rotor.

9. The system as recited in claim 1, further comprising an air dryer system that extends through the first modular section along the axis.

10. The system as recited in claim 9, wherein the air dryer system comprises a fan and a flexible perforated tube that extends from the fan along the axis.

11. The system as recited in claim 10, further comprising a generator system within the top load hopper to communicate heated air into the flexible perforated tube.

12. The system as recited in claim 1, wherein the top load hopper comprises a flexible hopper.

13. The system as recited in claim 12, wherein the pre-cleaner roller set comprises a multiple of perforated rollers.

14. The system as recited in claim 13, further comprising a fan along a roller axis of each pre-cleaner roller of the pre-cleaner roller set.

15. The system as recited in claim 14, wherein the fan directs an airflow within each respective precleaning roller to facilitate removal of chaff from the grain during precleaning which is blown along each roller axis to be ejected though an exhaust opposite the respective fan.

16. The system as recited in claim 15, further comprising a sieve structure below the pre-cleaner roller.

17. The system as recited in claim 16, wherein the sieve structure comprises a two-tier arrangement angled at 10 degrees with respect to horizontal toward each side of the top load hopper section.

18. The system as recited in claim 1, further comprising an unloading section downstream of the first modular section.
